(19) United States
(12) Patent Application Publication
(10) Pub. No.: US 2010/0176924 A1
(43) Pub. Date: Jul. 15, 2010

(54) RFID System with Improved Tracking Position Accuracy

(75) Inventors: Forrest S. Seitz, Beaverton, OR (US); Joshua K. Hoyt, Portland, OR (US)

Correspondence Address: FOUNTAINHEAD LAW GROUP, PC;Chad R. Walsh, 900 LAFAYETTE STREET, SUITE 301, SANTA CLARA, CA, 95050, US

(73) Assignee: MU-GAHAT HOLDINGS INC., Road Town (VG)

(21) Appl. No.: 12/684,339

(22) Filed: Jan. 8, 2010

Related U.S. Application Data
(63) Continuation-in-part of application No. 12/351,774, filed on Jan. 9, 2009.
Application No. 12/351,774 is a continuation-in-part of application No. 12/427,147, filed on Apr. 21, 2009.
(60) Provisional application No. 61/143,722, filed on Jan. 9, 2009.

(51) Int. Cl. H04Q 5/22

(52) U.S. Cl. 340/10.1

(57) ABSTRACT

In one embodiment the present invention includes a radio frequency identification (RFID) system. The RFID system includes a reader system that generates electromagnetic energy, reader antennas that communicate information with RFID tags using the electromagnetic energy, switches that are coupled to the reader antennas. The reader system selectively controls the switches to short adjacent reader antennas. In this manner, the target (RFID tag) may be located with improved positional accuracy.

### CROSS REFERENCE TO RELATED APPLICATIONS

The present application claims priority to U.S. Provisional App. No. 61/143,722 filed Jan. 9, 2009 for “RFID System with Improved Tracking Position Accuracy”, which is incorporated herein by reference. The present application is a continuation in part of U.S. application Ser. No. 12/351,774 filed Jan. 9, 2009 for “Enhancing the Efficiency of Energy Transfer to/from Passive ID Circuits using Ferrite Cores”. The present application is a continuation in part of U.S. application Ser. No. 12/427,147 filed Apr. 21, 2009 for “H-Field Shaping using a Shorting Loop”.

### BACKGROUND

The present invention relates to radio frequency identification (RFID) systems, and in particular, to RFID systems that have a number of neighboring or adjacent antennas.

Unless otherwise indicated herein, the approaches described in this section are not prior art to the claims in this application and are not admitted to be prior art by inclusion in this section.

Tracking gambling tokens in real-time on a gaming table has the potential to revolutionize the gaming industry by providing cash management and improved security. Tying this data to individual players allows casinos to improve security and improve their player profiles.

Traditional RFID systems have tried to address this market with limited success. These systems use electro-magnetic radiation to energize the tag, download command instructions and read data using different frequency spectra, power levels, and data exchange protocols typically set by international standards organizations. These existing solutions suffer from several shortcomings, including: (1) limited read heights (chip stack height) resulting from antenna coupling and limited read ranges; (2) higher than acceptable read errors; (3) excessive read times; (4) high failure rates during manufacturing; (5) invasive retrofitting of gaming tables; and (6) poor discrimination between betting zones.

Traditional passive RFID circuitry is powered by an excitation field. When the excitation field is above a given threshold, the RFID circuit is energized. This circuit uses either amplitude modulation or phase modulation to encode data and transmit it back to the reader. This data is typically an ID that is used to track presence or absence in the excitation field.

Most RFID systems simply look for the presence/absence of tags in the energized field of interest. Systems with multiple reader antennas typically are used to improve coverage or extend the read range and allow for redundancy (same tag read by multiple readers).

In real-time gaming, the technical challenge is more than simply answering the question, “Are you there?” Of equal importance is the question, “Where are you?” The fidelity of knowing the position of the tokens in play determines suitability for specific games. For example: In blackjack, the betting zones are physically separated, making it easier to assign an ID to a specific betting zone (and thereby to a specific player). Other games (e.g. baccarat and roulette) have adjacent betting zones that require a higher degree of discrimination.

On a gaming table, each reader antenna is centered on a specific betting zone. The tags energized by the excitation field respond with their ID. Ideally, only the tags inside a specific betting zone respond to the excitation field from the corresponding antenna. Unfortunately, the selectivity of the reader is dependent on the shape of the H-field generated by the antenna. If the betting zones are closely spaced—or the H-field is not well controlled—this may result in reading tags from adjacent betting zones, causing potential errors.

One technique for assigning an ID to a specific betting zone is by comparing signal strengths of IDs measured by the reader of each betting zone. If an ID is read by multiple readers, the ID is simply assigned to the reader/betting zone with the strongest signal. Successful assignment to the appropriate zone requires careful design of the reader and tag antennas to maximize the difference in signal strength. There is a need for techniques to increase this difference in order to improve the system's ability to discriminate and minimize errors.

### SUMMARY

Embodiments of the present invention improve the positional accuracy of reading RFID tags.

In general, embodiments of the present invention perform shorting of adjacent antennas for improved discrimination using signal strength information.

According to an embodiment, an implementation described in this application not only looks for the presence of tags—it also operates to define the location of each tag in the field. When tags are widely spaced, and the energized field of each reader antenna does not overlap with any other energized field, the tags are read by only one reader and one can thereby associate each tag with a specific reader and hence define its location. In this case, the spatial resolution is determined by the characteristics of the energized field. In order to assign a tag to a specific location, there is a need to be able to define a “border” between adjacent or neighboring antennas and to develop techniques for discriminating between tags inside the border and tags outside the border. One technique used to define this border is the difference in received signal strength of a given tag as seen by each reader. The reader that receives the strongest signal is (hopefully) the one that defines the volume/area of interest. Various techniques may be used to increase the difference is signal strength received by each reader, thereby further improving discrimination.

According to one embodiment, the RFID reader controls a switch that selectively shorts out adjacent or neighboring reader antennas. Doing so re-directs the H-field generated by the remaining energized antenna in a manner that minimizes cross-talk and improves discrimination.

A second embodiment uses two orthogonal arrays of antennas—one for each coordinate—to identify the location in two dimensions of each tag in the field. The reader shorts out neighboring antennas to first determine one coordinate and then repeats this process on the orthogonal array of antennas to determine a second coordinate. The combination of these two coordinates defines the location of the tag. Similar steps are taken to determine the location of the other tags in the field.

The following detailed description and accompanying drawings provide a better understanding of the nature and advantages of the present invention.

### BRIEF DESCRIPTION OF THE DRAWINGS

FIGS. 1A, 1B, 1C and 1D show an RFID gaming system according to an embodiment of the present invention.

FIGS. 2A, 2B and 2C show various aspects of the performance of embodiments of the present invention.

FIG. 3 is a graph showing a comparison between an existing air core RFID tag and a ferrite core RFID tag according to an embodiment of the present invention.

FIG. 4 is a block diagram of a gaming table according to an embodiment of the present invention.

FIG. 5 is a block diagram of the motherboard (see FIG. 4) according to an embodiment of the present invention.

FIG. 6 is a block diagram of the daughter board (see FIG. 4) according to an embodiment of the present invention.

FIG. 7 is a block diagram of the antenna (see FIG. 4) according to an embodiment of the present invention.

FIG. 8A is a top view (cut away) and FIG. 8B is a bottom view (cut away), of a token according to an embodiment of the present invention.

FIG. 9 is a block diagram of a token according to an embodiment of the present invention.

FIG. 10 shows three views of a typical loop antenna.

FIG. 11 shows three views of a loop antenna and a shielding loop according to an embodiment of the present invention.

FIG. 12 shows three views of a loop antenna and a shielding loop according to an embodiment of the present invention.

FIG. 13A shows a schematic representation of an array of antennas (such as might be used on a roulette table), according to an embodiment of the present invention.

FIG. 13B shows a representation of a roulette table that may be used with an embodiment of the present invention.

FIG. 14A is a diagram showing betting zones of different geometries, according to an embodiment of the present invention.

FIG. 14B shows an embodiment of the control structure for the roulette table (see FIG. 13B).

FIG. 15 shows yet another embodiment of the present invention using two orthogonal arrays of linear antennas.

FIG. 16 illustrates a system according to an embodiment of the present invention.

FIG. 17 illustrates a system according to an embodiment of the present invention.

FIG. 18 illustrates a system according to an embodiment of the present invention.

### DETAILED DESCRIPTION

Described herein are techniques for improved position tracking in RFID systems. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, the terms “neighboring” and “adjacent” are used. In general, the terms are used interchangeably. When precision is desired, two “adjacent” areas do not include a gap (or other area) therebetween, and two “neighboring” areas include a gap (or other area) therebetween.

Embodiments of the present invention may be used with the features described in other patent applications owned by the assignee of the present application. One such application is U.S. application Ser. No. 12/351,774 filed Jan. 9, 2009 for “Enhancing the Efficiency of Energy Transfer to/from Passive ID Circuits using Ferrite Cores”, which is incorporated herein by reference. Another such application is U.S. application Ser. No. 12/427,147 filed Apr. 21, 2009 for “H-Field Shaping using a Shorting Loop”, which is incorporated herein by reference.

An embodiment of the present invention is directed to an RFID system in a gaming environment. For ease of description, the gaming environment provides context for describing an embodiment. It is to be understood that the form factor of the RFID system may be adjusted, and that RFID systems embodying principles of the invention may be used in environments other than gaming environments.

An embodiment of the present invention includes a shielding loop. (The shielding loop may also be referred to as a shield or a shorting loop.) The shielding loop surrounds the reader antenna and distorts the magnetic field to constrain the field in a manner that aids in defining the read region that corresponds to a reader antenna. A well-defined read region with identifiable borders allows one to discriminate between tags inside the border and tags outside the border.

The discussion below is organized as follows. First, a general description is provided that describes a number of gaming system embodiments that may include a shielding loop. The gaming system embodiments may contain features such as gaming tables, reader systems, and RFID gaming tokens. Second, various details of the gaming system embodiments are provided. These details may include features such as the ferrite core in the RFID gaming tokens. Third, the details of the shielding loop are provided. Fourth, the details of antenna shorting are provided. Finally, the various combinations of the various elements are described.

General Description

Although the description uses the term “ferrite”, this term is to be broadly interpreted to refer to any type of magnetically permeable material. In general, a material is magnetically permeable if its magnetic permeability is greater than that of air.

One feature of an embodiment is that the amount of energy that may be scavenged by each RFID tag from the excitation (reader) antenna is increased, as compared to many existing RFID systems. Another feature of an embodiment is that the efficiency of the energy transfer from the excitation (reader) antenna to the RFID tag is increased, as compared to many existing RFID systems. Another feature of an embodiment is that the efficiency of the data transfer from the excitation (reader) antenna to the RFID tag is increased, as compared to many existing RFID systems. Another feature of an embodiment is that the efficiency of the data transfer from the RFID tag back to the reader antenna is increased, as compared to many existing RFID systems. These increases in energy and data transfer may include one or more of the following features according to an embodiment: increased stack height of gaming tokens that can be read (resulting from increased read range); reduced read errors within a stack of gaming tokens; improved discrimination between tokens inside a “betting spot” and tokens outside the betting spot; and improved read times.

As further detailed below, a gaming token embodiment includes a RFID tag with a ferrite core that steers the magnetic flux emanating from an excitation source. In a gaming environment, where gaming tokens may be stacked in a column, the ferrite materials in the center of the token efficiently steer the magnetic flux up the stack to energize the chips in the stack. The excitation source (reader antenna) may be embedded in the playing surface of the gaming table.

In contrast, typical RFID readers (using tags without a ferrite core; sometimes referred to as “air core” tags) radiate their energy broadly. This less efficient coupling between reader and tags is a significant factor in read range and poor discrimination.

The presence of the ferrite core, according to an embodiment, may enable one or more of the following features as compared to air core tokens:

1. The increased efficiency of the coupling between the excitation (reader) source and the passive gaming token extends the read range of the “tag-reader” system.
2. The increased efficiency of the coupling between the excitation source and the passive gaming token allows the system designer to trade off read range in exchange for a gaming token with a lower “Q” with little or no net negative impact on read range. Assuming sufficient energy is available to power the RFID tag, this lower Q can minimize sensitivity to the interaction that results when multiple tags are in close proximity.
3. Sufficient energy can be transferred to the passive circuitry in the token that a more powerful processor can be used to achieve improved data rates, security, and error detection/correction.
4. The increased efficiency of the coupling between the gaming token and the excitation source can be used to achieve improved data rates, security, and error detection/correction.
5. Controlling the shape of the h-field makes it easier to discriminate between tokens that should be read (i.e., tokens that are in a selected betting zone) from tokens that should not be read (i.e., tokens that are not in the selected betting zone). This will minimize read errors due to cross-talk between adjacent betting zones.

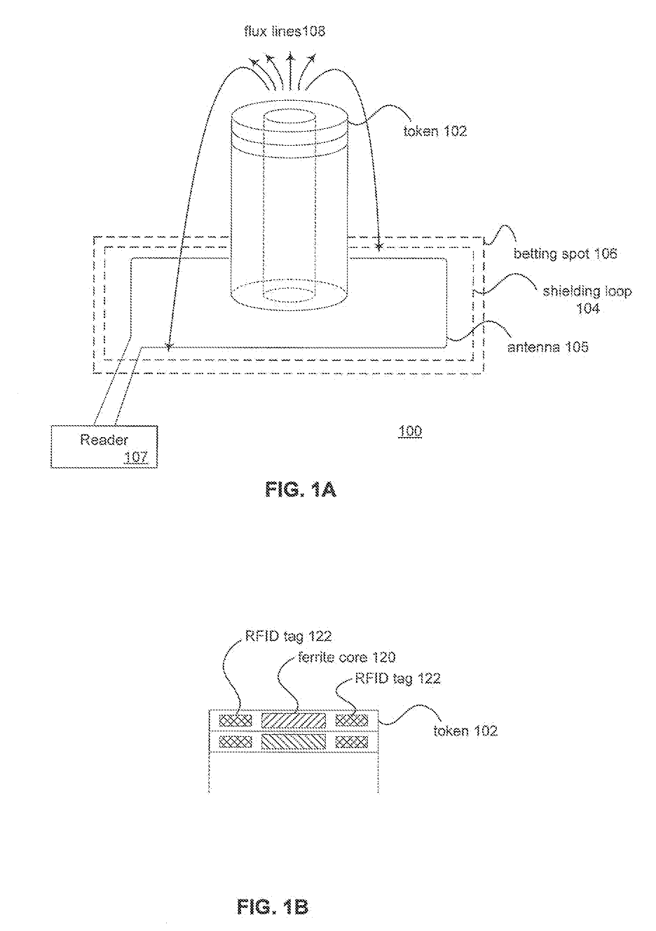

FIGS. 1A, 1B, 1C and 1D show an RFID gaming system 100 according to an embodiment of the present invention.

FIG. 1A shows a number of gaming tokens 102 stacked within a shielding loop 104 that surrounds a betting spot 106. The betting spot 106 may be located on a gaming table (not shown) on which the gaming tokens 102 may be placed to make a bet. The gaming table may include a reader 107 that has an RFID antenna 105 and other RFID reader electronics (not shown) for reading an RFID tag located within each gaming token 102.

The shielding loop 104 constrains flux lines 108 generated by the gaming tokens 102 in response to electromagnetic energy emitted by the RFID reader. The flux lines 108 (also referred to as the h-field) are generated by the RFID reader 107. The gaming tokens 102 are energized by this field. This field can be modulated by either the reader 107 (for a data uplink to the tokens 102) or the gaming tokens 102 (for a data downlink to the reader 107).

FIG. 1B is a cut away side view showing more details of the gaming tokens 102. Each gaming token 102 includes a ferrite core 120 and an annular RFID tag 122.

FIG. 1C shows a cut-away top view of the gaming token 102. The ferrite core 120 can be seen, as well as a loop antenna 124 as a component of the RFID tag 122.

FIG. 1D shows a cross-sectional view of the gaming token 102. The ferrite core 120 can be seen, as well as the loop antenna 124 and the other electronics 126 of the RFID tag 122.

The RFID tag 122 may be magnetically coupled. That is, although the electromagnetic radiation involved in RFID applications includes both an electrical field (e-field) and a magnetic field (h-field), an embodiment of the present invention uses the magnetic field. Essentially, a transformer is formed, with one winding in the excitation antenna in the reader and multiple windings—one in each token. In many existing RFID systems, the transformer has an “air core”. This air core may be inefficient, but this inefficiency may be acceptable if one does not knowing the location of the RFID tag with precision. In contrast, embodiments of the present invention use a “ferrite core” to improve the performance of the transformer created by the excitation antenna and the token antenna(s) 124. The use of ferrite cores is particularly effective when the gaming tokens 102 are stacked and the ferrite cores 120 deform the magnetic flux component of the electromagnetic energy received from the reader. This deformation of the magnetic flux concentrates the flux lines through the ferrite cores 120. The concentrated flux lines through the core 120 couple the electromagnetic energy in a more efficient manner than in a token 102 that lacks the ferrite core 120. In effect, the ferrite cores 120 steer the flux field to improve performance, as more fully described below.

The token antenna 124 scavenges electromagnetic energy (for example, from the h-field) from the reader. The other electronics 126 rectifies the energy and uses the energy to drive a processor. Data transfer from reader to token can be superposed on the carrier using modulation. Similarly, the processor can modulate the carrier to perform data transfer from token to reader to identify the RFID tag 122. According to one embodiment, a 13.56 MHz carrier is used. The carrier frequency 13.56 MHz has been found to couple well to ferrites.

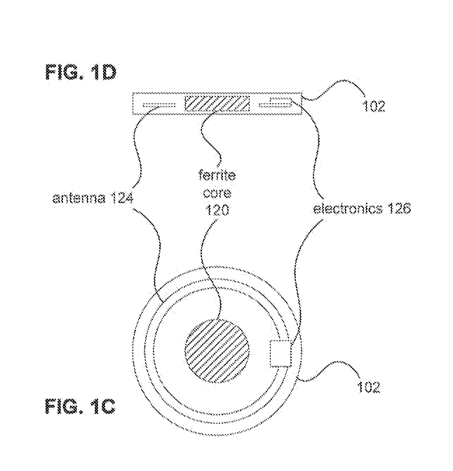

FIGS. 2A, 2B and 2C show various aspects of the performance of embodiments of the present invention.

FIG. 2A is a cut away side view showing two stacked gaming tokens 102. Each gaming token 102 has a ferrite core 120. The thickness of the gaming token 102 is T and the thickness of the ferrite core is t. The ratio t/T is referred to as the “% ferrite”.

FIG. 2B is a perspective view showing a number of gaming tokens 102 stacked at a stack height of 3 inches. This stack height is used to compare embodiments of the present invention to other techniques.

FIG. 2C is a graph showing the performance of various materials. The x-axis shows the “% ferrite” (see FIG. 2A and related discussion) and the y-axis shows the signal strength. (The “% ferrite” of 100% indicates that the thickness of the ferrite core 120 is the same as the thickness of the gaming token 102.) For the material “material2”, the line 202 shows the received signal strength of “dB” at 100%. Given line 202 as a baseline for the desired signal strength, other materials may be used to give different performance characteristics. For example, the material “material1” shown by the line 204 indicates a thinner ferrite core 120 can be used to give the same performance as “material2”. The material “material3” shown by the line 206 indicates a thicker ferrite core 120 is needed to give the same performance as “material2”. As can be seen, more ferrite as a percentage of the thickness of the gaming token 102 results in better coupling between reader and tag. In addition, different ferrite materials have different performance characteristics.

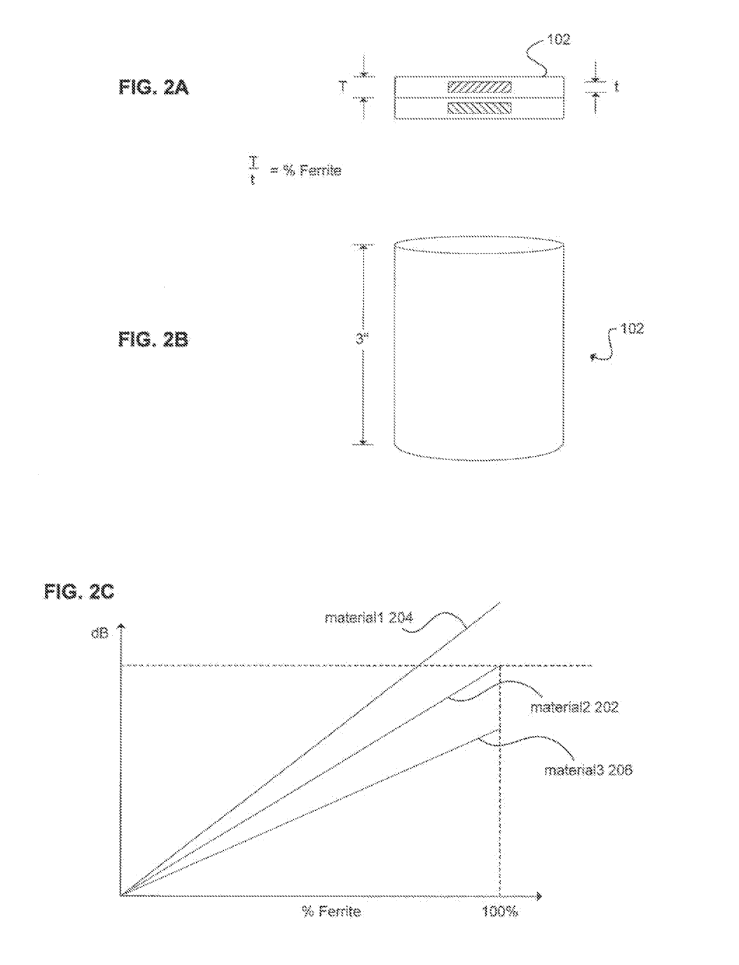

FIG. 3 is a graph showing a comparison between an existing air core RFID tag and a ferrite core RFID tag according to an embodiment of the present invention. The x-axis shows the stack height of a stack of gaming tokens 102 (see FIG. 1A) and the y-axis shows the signal strength of the signal received by the topmost gaming token in the stack. For an air core RFID tag, the line 300 has a signal strength dB0 at the stack height H0. This stack height H0 may correspond to approximately 2.5 inches in existing systems. For a ferrite core RFID tag, the line 302 has the signal strength dB0 at the stack height H*. The stack height H* is greater than the stack height H0. Thus, embodiments of the present invention allow reading at greater stack heights as compared to existing systems. Correspondingly, for a given stack height H0, the received signal strength of the line 302 is greater than that of the line 300. Thus, embodiments of the present invention provide improvement in read height as compared to existing systems. In effect, the multiple stacked tags create a rod of ferrite material that steers the magnetic flux field up through the stack.

As discussed above, many existing RFID tags have a relatively high Q. The Q is relatively high to increase sensitivity and read range. However, when multiple tags are in close proximity, they tend to interact. This interaction changes their resonant frequency of operation. As a result, the tags are not energized and/or data is not successfully exchanged.

According to an embodiment of the present invention, the antennas in the gaming tokens 102 have a relatively lower Q than those in existing RFID tags. Having a relatively lower Q may also be referred to as being de-tuned. De-tuning helps to address the problem of unwanted interactions between tags, but also severely limits sensitivity and hence the read range. In contrast to many existing air core RFID tags, embodiments of the proposed invention use ferrite cores 120 to compensate for this loss of read range. When these gaming tokens 102 are stacked, the ferrite cores 120 concentrate the h-field and steer the flux. This allows the use of de-tuned tags which are not compromised by the presence of adjacent tags. The decrease in sensitivity from de-tuning is offset by the focused h-field. The result: the ability to read multiple tags in close proximity while maintaining excellent read range. In contrast, many existing air core RFID tags either cannot be read in close proximity or suffer in read range.

As a specific example, the Q of many existing RFID tags is between 10 and 20, whereas the Q of the antennas in the gaming tokens 102 is close to zero (in fact, a designer may want to make the Q as close to zero as possible). Ideally, the antenna in the gaming token 102 may present itself as a pure resistive load. In practice, however, there is parasitic capacitance that contributes to a modest Q (typically less than 1). For the system designer, one notable factor that determines what Q is possible (to maximize read range) is how closely coupled the tags are—which is dependent on how closely spaced they are. According to an embodiment, tags with a Q less than 5.0 provide an acceptable read range. According to an embodiment, tags with a Q less than 1.0 provide an improved read range.

According to an embodiment, the antennas in the gaming tokens 102 are untuned and have a resonance frequency that is well above 13.56 MHz. The lack of a tuned antenna limits sensitivity and hence the read range. As with the low Q antenna embodiment discussed above, the ferrite cores 120 concentrate the h-field and steer the flux, allowing the use of untuned or de-tuned tags which are not compromised by the presence of adjacent tags.

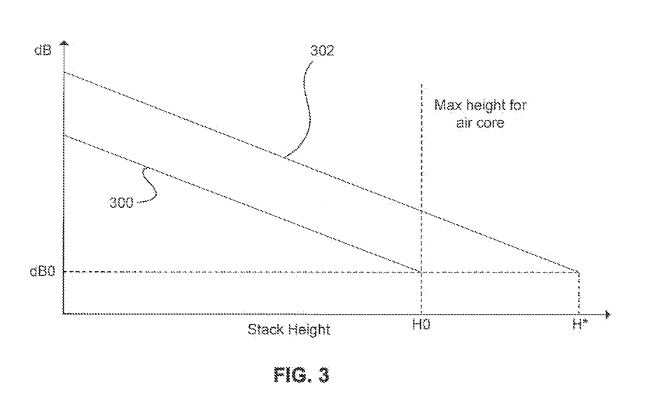

FIG. 4 is a block diagram of a gaming table 700 according to an embodiment of the present invention. In general, the embodiment of FIG. 4 may be referred to as a reader system. The gaming table 700 includes eight betting spots 702a-702h (collectively 702), eight antennas 704a-704h (collectively 704), eight shielding loops 706a-706h (collectively 706), eight daughter boards 708a-708h (collectively 708), a motherboard 710, and a control system 712. (Some of the description of these components, e.g., the betting spots, the antennas, and the shielding loops, may be repeated from the descriptions of components having similar names that were discussed in previous sections.) The gaming table 700 may be used in conjunction with the ferrite core gaming tokens 102.

The gaming table 700, according to an embodiment, may include one or more of the following attributes: (1) a 13.56 MHz carrier; (2) a “modified Aloha” protocol; (3) a 256 u-sec “data frame” that modulates the carrier; (4) a 16-bit data word for commands to the tokens (140 KHz data rate or 7 u-seconds per bit); and (5) a 46-bit token ID data (500 KHz data rate or 2 u-seconds per bit; 31 bits for ID plus 13 bits for error detection). According to another embodiment, the data rate is 125 KHz or 8 u-seconds per bit. According to another embodiment, the data rate is 250 KHz or 4 u-seconds per bit. According to yet another embodiment, a start bit and a stop bit may also be transmitted.

The RF communication uses a 13.56 MHz carrier generated by the motherboard 710 and sent to each daughter board 708. 13.56 MHz was chosen for three reasons: (1) the ferrite cores are permeable at this frequency, (2) data rates are reasonable, (3) FCC frequency allocations for this type of application.

Even though the “ferrite core” concept may not strictly be an RFID technology, the energy and data exchange leverages a “modified Aloha” protocol common to many RFID systems. This protocol was selected because, when there is a good signal to noise ratio and a reasonable estimate of the number of tags in the field is known, it provides a fast read cycle. Characteristics of this modified Aloha protocol include:

1. A “master-slave” command structure with all commands initiated by the reader.
2. A defined number of response “windows”. Ideally, the number of windows balances the need to manage collisions (more windows is better) with the desire for fast read cycle times (fewer windows is better).

A complete read cycle begins by turning on the 13.56 MHz carrier signal to power up the tokens in the excitation field and ends when all tokens in the excitation field have been read. Once powered up, the tokens wait for a command. The DSPs on each daughter board 708 modulate the carrier to send commands and data to the tokens at a data rate that the tokens (with only modest processing power) can capture. The number generator process in each token “randomly” assigns a response window. According to an embodiment, the token processor uses the iteration and window size to determine which of the bits in the ID number are used to define a response window. The daughter boards 708 attempt to read the ID of any chips within the range of its antenna. An error detection scheme identifies any collisions. Tokens that are read successfully are put to sleep and the process is repeated. Once all token IDs have been read, the data is sent to the PC.

The token data rate is the fastest that its internal oscillator can drive (250 KHz according to an embodiment); the DSP has the processing horsepower to manage the higher data rate of the down-link from the tokens. This asymmetry in data rates (up-link vs. down-link) aligns with the volume of data to get good read cycle times (much less bandwidth is required for commands than for token IDs). Both the 16-bit commands and the 46-bit IDs fit into the 256 u-sec data frame.

The number and arrangement of the betting spots 702 may be varied depending upon the specifics of the game to be played. In general, a betting spot 702 may be placed anywhere on the table 700 near which a measurement of RFID tags is desired to be made. (“Near” is a relative term that may vary depending upon the specific features implemented in the system. With the specific example configuration described here, “near” produces acceptable read performance for stacks of RFID-enabled tokens with ferrite cores up to 6 inches high above the antenna 704.) More specifically, the arrangement of betting spots 702 on the table 700 corresponds to a blackjack game where the only desired information is the IDs of gaming tokens currently being wagered.

The number and arrangement of the antennas 704 generally correspond to the number and arrangement of the betting spots 702. For example, for a given play area, the size of and spacing between the antennas 704 can be adjusted according to a desired performance threshold, and the betting spots 702 conform to the locations of the antennas 704. According to an embodiment, the antenna 704 may be rectangular in shape and 2 inches by 4 inches in size. According to an embodiment, the antenna 704 may be circular in shape and 4 inches in diameter. Other closed geometries (triangular, rhomboidal, pentagonal, hexagonal, ovular, etc.) or combinations of closed geometries (semi-circular, combined semi-circular and semi-rectangular, etc.) or even irregular closed geometries may be used in other embodiments. According to an embodiment, the antenna 704 may be spaced from the shielding loop 706 by a gap of one-quarter inch. According to an embodiment, the antenna 704 may be constructed on a FR-4 (flame retardant) printed circuit board. According to an embodiment, the antenna 704 may have a thickness of 0.031 inches.

The motherboard 710 can interface to the control system 712 that may be configured to operate in either a local manner or in a remote manner. When the control system 712 is local, the motherboard 710 may be connected via a connection such as USB (universal serial bus). When the control system 712 is remote, the motherboard 710 may be connected via a LAN (local area network) connection such as Ethernet. The Ethernet connection allows the control system 712 to be remotely located to control one or more gaming tables 700 as part of a larger system to monitor fraud or reward loyalty. Alternatively, the USB connection allows the mother board 710 to interface to the local control system 712 to help run demos, de-bug prototypes, and/or integrate diverse systems into a common data format. The local control system 712 can also maintain a copy of the database of “valid” IDs to insure continuous play even in the event of a breakdown in the LAN.

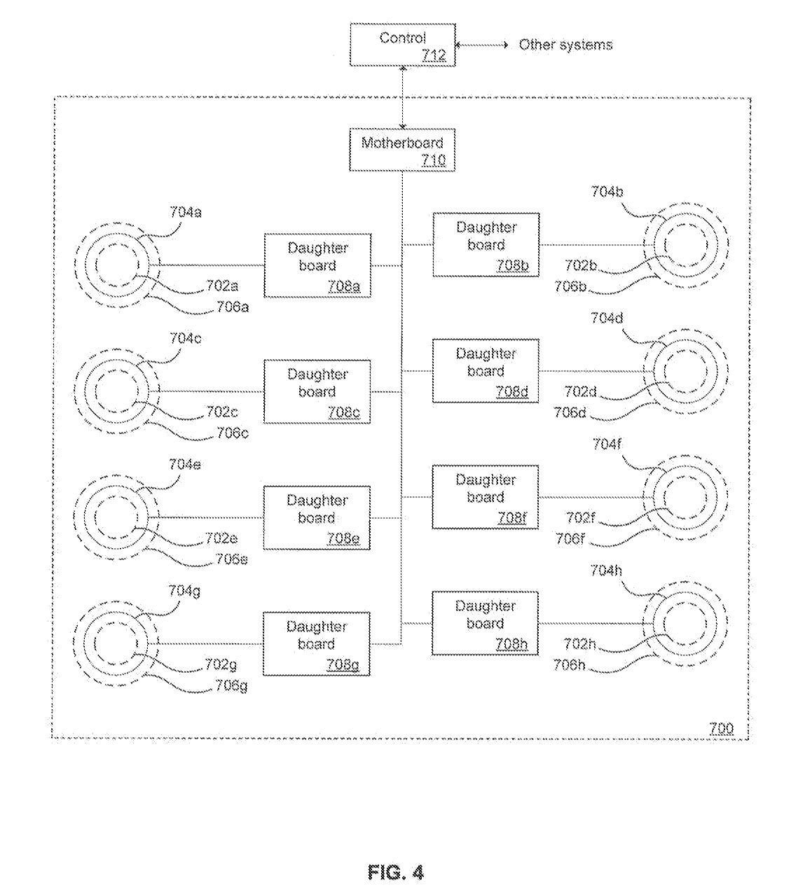

FIG. 5 is a block diagram of the motherboard 710 (see FIG. 4) according to an embodiment of the present invention. The motherboard 710 includes a power supply 802, two control system interfaces 804a and 804b, a controller 806, and eight daughter board interfaces 808a-808h (collectively 808).

The power supply 802 supplies power to the controller 806 and the control system interfaces 804a and 804b.

The controller 806 implements the functionality of the motherboard 710. These functions may include providing power to the daughter boards 708, generating the carrier frequency (e.g., 13.56 MHz) to drive the reader antennas, generating the clock (e.g., 4 KHz) that the daughter boards 708 use to define the command and data windows, formatting the decoded serial data received from the tokens, etc. The controller 806 may be implemented with a complex programmable logic device (CPLD) or other type of circuit structure. According to an embodiment, the controller 806 may be implemented with a XC95144XL-10TQG100C CPLD from Xilinx, Inc., San Jose, Calif.

The control system interface 804a interfaces the motherboard 710 with the control system 712. According to an embodiment, the control system 712 connects to the motherboard 710 in USB format and the controller 806 communicates in serial format, so the control system interface 804a implements a USB-to-serial interface. The control system interface 804a may be implemented by a FT232RL device from Future Technology Devices International Ltd., Glasgow, United Kingdom. According to an embodiment, the control system 712 connects to the motherboard 710 in Ethernet format, so the control system interface 804b implements an Ethernet connection. The control system interface 804b may be implemented by a LPC2368FBD100-S microcontroller from NXP Semiconductors, Eindhoven, The Netherlands.

The daughter board interfaces 808 provide connections between the motherboard 710 and the daughter boards 708. The system designer may choose to add or reduce the number of daughter boards 708 depending on the number of betting spots and the speed at which they must be read. According to an embodiment, one daughter board 708 drives one antenna 704. According to an embodiment, one daughter board 708 drives multiple antennas 704, and the read signals are multiplexed. The number of simultaneous reads will impact the required power.

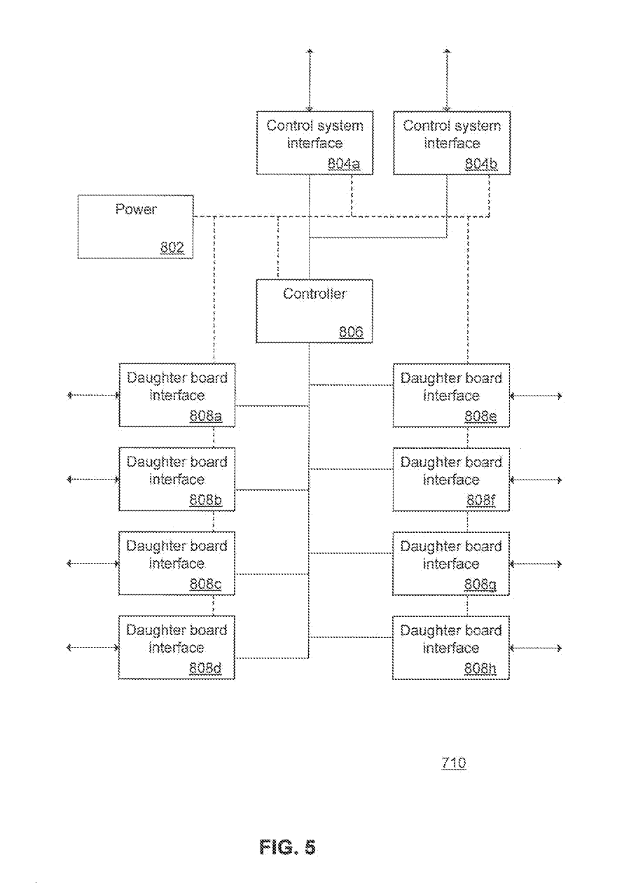

FIG. 6 is a block diagram of the daughter board 708a (see FIG. 4) according to an embodiment of the present invention. The daughter board 708a includes a transmitter 902, a receiver 904, a directional coupler 906, and an antenna switch 908.

The transmitter 902 includes an amp supply 920, an amplitude modulator 922, an amplifier 924, and a bandpass filter 926. The transmitter 902 receives three signals from the motherboard: a power signal PWR_PWM, an amplitude modulated data signal AM_DATA, and the 13.56 MHz carrier signal. The transmitter 902 modulates the data signal onto the carrier signal and provides the modulated carrier signal to the directional coupler 906.

The directional coupler 906 provides the modulated carrier signal to the antenna switch 908, which provides the modulated carrier signal to the antenna 704 for transmission.

(According to an embodiment, the daughter board 708a includes two antenna connectors and can drive two antennas. The antenna switch 908 determines which of the antennas are used.) The tags scavenge the transmitted energy and, in response, further modulate the signal with their ID information, which the directional coupler 906 provides to the receiver 904.

The receiver 904 includes mixers 930a and 930b, low pass filters 932a and 932b, amplifiers 936a and 936b, differential amplifiers 938a and 938b, analog to digital converters 940a and 940b, a programmable logic device 942, and a DSP (digital signal processor) 944. The programmable logic device 942 may be a FPGA such as the XC3S250E-4TQG144C device from Xilinx Inc., San Jose, Calif. The DSP 944 may be TMS320F2812PGFA device from Texas Instruments, Dallas, Tex.

The receiver 904 receives the signal as further modulated by the tags (provided by the directional coupler 906) and two versions of the 13.56 MHz carrier frequency (one shifted 90 degrees). The receiver 904 then demodulates the tag ID information and provides serial data to the motherboard 710.

Reader Antenna Details

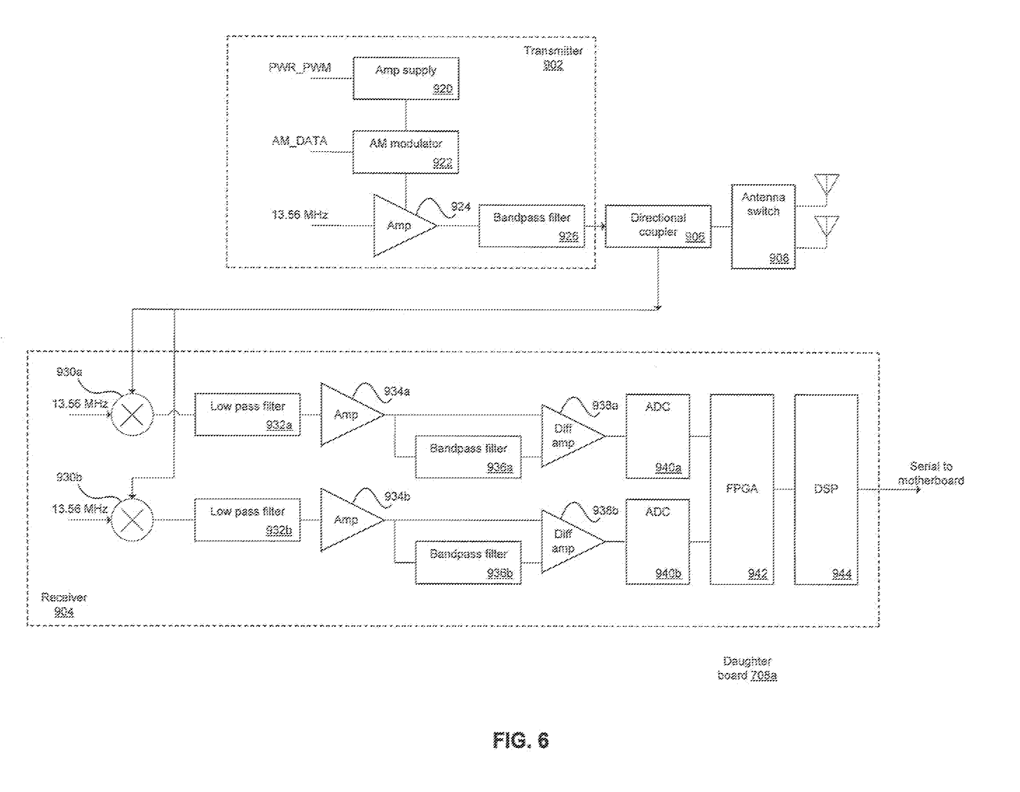

FIG. 7 is a block diagram of the antenna 704a (see FIG. 4) according to an embodiment of the present invention. The antenna 704a includes a connector 1002, an optional switch 1004, a matching circuit 1006, an antenna loop 1008, and a shielding loop 1010. These components may be implemented on a FR-4 printed circuit board assembly. Note that for complex antennas, a multi-layer PCB may be desirable. This may be especially true if adjacent antennas overlap.

The connector 1002 connects the antenna 704a to the daughter board 708. According to an embodiment, the connection to the daughter board 708 is a shielded coaxial cable, and the connector 1002 is a SMA (SubMiniature version A) connector.

The optional switch 1004 can be used to short out the antenna loop 1008 when the antenna loop 1008 is not in use. The switch 1004 may be controlled by a DC bias on the antenna cable that may be generated by the daughter card. The switch 1004 acts as an additional shielding loop to reduce the field strength in this antenna's betting spot when an adjacent betting spot is being actively driven. This may improve discrimination between tokens in adjacent betting spots.

The matching circuit 1006 may be a 50 Ohm impedance matching circuit.

The antenna loop 1008 may be a loop antenna. The antenna loop 1008 may be in various form factors according to the specifics of the desired betting area and the desired performance. According to an embodiment, the antenna loop 1008 may be in the form of a rectangle sized at 2 inches by 4 inches. According to an embodiment, the antenna loop 1008 may be in the form of a circle with a diameter of 4 inches.

Gaming Token Details

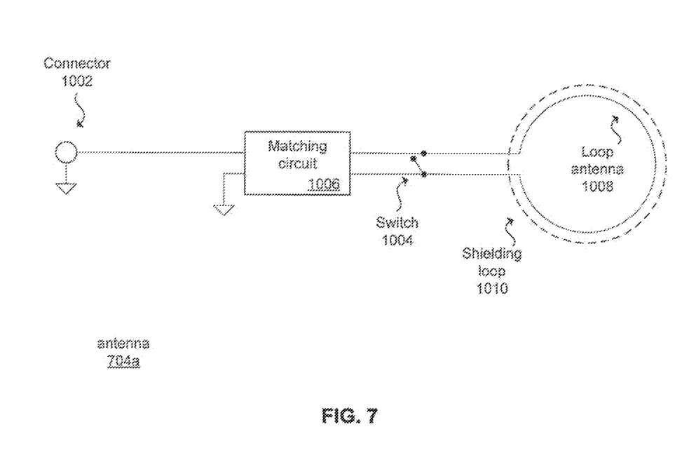

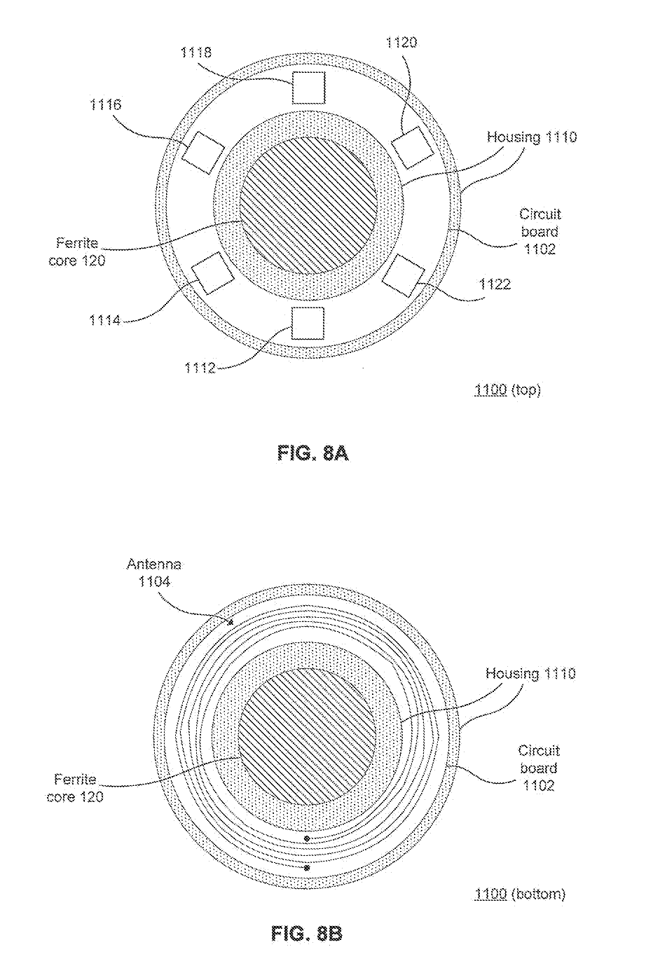

FIG. 8A is a top view (cut away), FIG. 8B is a bottom view (cut away), and FIG. 9 is a block diagram, of a token 1100 according to an embodiment of the present invention. The token 1100 generally includes a ferrite core, an antenna, and tag electronics. More specifically, the token 1100 includes a printed circuit board 1102, an antenna 1104, the ferrite core 120, a plastic housing 1110, a bridge rectifier 1112, a current source 1114, a shunt voltage regulator 1116, a receive filter 1118, a microprocessor 1120, and a transmit transistor 1122.

The token 1100 may be a gaming token such as is suitable for use in casinos. The token 1100 may be circular with a diameter of 1.55 inches (39.4 mm) and a thickness of 0.125 inches (3.18 mm). These parameters may be varied as desired.

The printed circuit board 1102 may be generally circular in shape, in order to conform to the form factor of circular gaming tokens. The printed circuit board 1102 may be of FR-4 material and 0.020 inches in thickness.

The antenna 1104 may be an 8-turn antenna etched on one side (e.g., the bottom) of the circuit board 1102. These antennas may be constructed with 8 mil traces and 7 mil spacing. The inductance of the 8 turn antenna may be 3 uH. Antennas with different numbers of turns may be implemented with a different balance between inductance and resistance, according to design needs.

Many existing RFID tags use a diode rectifier followed by a voltage clamp to limit the required operating voltage range of the tag and thereby protect the tag from over-voltage. In this embodiment, the power supply may be a linear power supply where there is a bridge rectifier 1112 followed by a current source 1114 and then a voltage clamp (shunt voltage regulator) 1116. This architecture does not clamp the voltage across the coil as is typically done in RFID tags. This linear supply allows tags to operate over a broad range of magnetic field intensities. This allows tags to be read on the top of the stack—where the field is lowest—and near the bottom of the stack—where the field is highest. The net effect is an increased read range. The linear power supply may be as described in U.S. Provisional Application No. 61/031,270 for “Dynamic Power Absorption of a Loop Antenna for Passive RFID Tags” filed Feb. 25, 2008.

The microprocessor 1120 may be a PIC microcontroller from Microchip Technology Inc., Chandler, Ariz. The microprocessor 1120 stores the ID of the token 1100, decodes commands from the reader, and encodes the ID of the token 1100 onto the 13.56 MHz carrier. The microprocessor 1120 includes an internal comparator that is coupled to the receive filter 1118.

The ferrite core 120 may be as described above (see, for example, FIG. 1B). The ferrite core 120 harnesses the H-field and steers it through the antenna 1104. The primary physical attribute of the ferrite is its permeability. Any material that is magnetically permeable and effectively steers the H-field through the antenna loop will improve performance. Ferrite devices are commonly used with frequencies up to 1 GHz. According to an embodiment, the ferrite core 120 has a permeability of 125, plus or minus 20% (e.g., between 100 and 150).

According to an embodiment, the ferrite core 120 is made of a high frequency perminvar NiZn ferrite with a range of inductive applications up to 25 MHz with low losses. A suitable material is the “M” Material from National Magnetics Group, Inc., Bethlehem, Pa. According to an embodiment, the ferrite core 120 is a molded plastic material with a ferrous filler or a ferrous additive. Other materials that may be used are powdered iron, ground up ferrite, soft iron, or a nickel-iron-molybdenum alloy (e.g., molypermalloy), although they may be generally better suited to frequencies lower than 13.56 MHz.

According to an embodiment, the frequency of 13.56 MHz may be used. Different frequencies may be used in other embodiments.

The ferrite core 120 has a thickness that generally conforms to the form factor of the token 1100. For example, the ferrite core 120 may have a thickness of 3.175 mm.

The ferrite core 120 has a diameter that generally conforms to the form factor of the token 1100 and the other internal components. For example, the ferrite core 120 may have a diameter of 12.7 mm. This diameter allows tokens to be mis-aligned in a stack and provide sufficient overlap between adjacent tokens such that flux up the stack is not degraded (i.e., performance is not sensitive to how well the stack is aligned). Practical ranges for the diameter of the ferrite in standard (round) gaming tokens can be as small as 2 mm and as large as 35 mm, depending on other physical requirements. Other form factors such as the use of “plaques” may allow greater freedom in the choice and location of the ferrite element(s). For example, a rectangular plaque may include two circular ferrite cores 120.

The size of the ferrite core may be increased or decreased according to the form factor of the token 1100 and the desired performance characteristics. As long as it fits, there is no reason one could not make the ferrite core 120 bigger in diameter. As long as there is sufficient overlap to not degrade flux up the stack, one could make the ferrite smaller in diameter. There does not appear to be much sensitivity to space between antenna windings and the outside diameter of the ferrite.

The ferrite core 120 may be circular in shape but any shape that fits inside the antenna loop is acceptable. The circular shape was chosen for symmetry and ease of manufacture. The ferrite core 120 may be positioned at locations other than the center of the token 1100 if desired.

According to an embodiment, the diameter of the ferrite core 120 may be increased up to the diameter of the token. The antenna may be wrapped around an outer edge of the token.

The top and bottom of the token 1100 may be covered with labels or stickers (not shown) to denote the denomination or other desirable information. The label may have a thickness of approximately 0.003 inches. This thickness minimizes any air gaps when the tokens are stacked (that is, it helps the ferrite cores in a stack of tokens to function as if they were a single monolithic rod of ferrite). The thickness of the label may be varied, as desired, with corresponding effects on the read performance. Alternately, the ferrite core may be exposed by using an annular sticker to further minimize any air gaps in the stack. The gap performance of between two tokens 1100 is given in TABLE 1, according to an embodiment.

TABLE 1

| | Gap | | | | | | |
|---|---|---|---|---|---|---|---|
| | 0% | 1.75% | 2.5% | 4.5% | 9% | 17.5% | 23.5% |
| Gain (dB) | 24 | 19 | 15.5 | 13 | 10 | 7 | 5.5 |

The “gap” refers to the space between ferrite cores 120, as a percentage of the thickness of each. (For example, a gap of 20% for a thickness of 3 mm corresponds to a 0.6 mm gap.) The gap may result from a label as described above, from a more robust covering for the token 1100, from debossed features on the token 1100, etc. The “gain” refers to the increased signal strength for tokens 1100 having the ferrite core 120 as compared to a token lacking the ferrite core 120. Thus, TABLE 1 shows that for a gap between 0% and 1.75%, the gain is between 24 dB and 19 dB. The information in TABLE 1 is dimensionless; that is, it does not depend upon the number of tokens 1100 in a stack.

The ferrite cores 120 can be manufactured either by cutting them from a solid rod or by sintering them in a special tool. Sintering allows the addition of aesthetic elements to be de-bossed on either one or both facets of the ferrite with little degradation in their performance. Furthermore, sintering allows the designer to add features to allow insert molding of the ferrites during the molding of the tokens.

According to an embodiment, ferrous material or small ferrite beads may be added to a plastic matrix, which is then used to mold part or all of the token 1100. In such an embodiment, the ferrite core 120 and the token 1100 refer to the same structure, and a separate element for the ferrite core 120 is not required.

According to an embodiment, more than one ferrite core may be in a token. According to an embodiment, a token may include more than one RFID tag (e.g., the tag electronics may provide multiple tag IDs for a token). According to an embodiment, more than one antenna may be in a token.

Shielding Loop Details

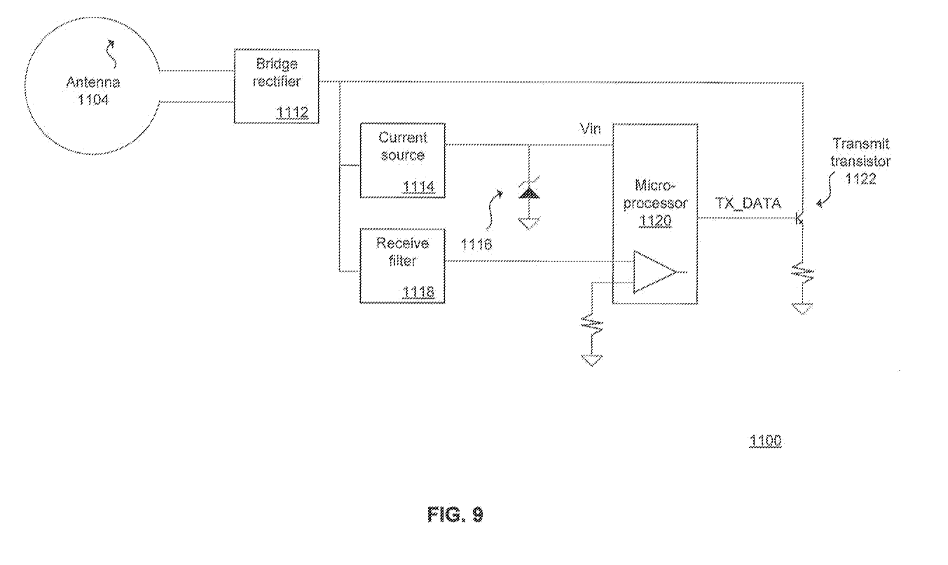

FIG. 10 shows three views of a typical loop antenna 1204. The top view shows a three-dimensional view of the flux lines 1200 and the loop antenna 1204. The middle view shows a cut away side view along Section A-A of the top view. The bottom view shows a graph of the field strength 1202 as one traverses across Section A-A of the loop antenna 1204. Two features are noteworthy: the “null” 1210 and the “tail” 1212. The “null” 1210 is a region of low sensitivity arising from horizontal flux lines 1200 in the h-field that do not intersect the horizontal antenna loop 1204. Ideally, the null 1210 is outside the defined borders of the betting zone. If the “null” falls inside the betting zone, there will be “dead spots” in the betting zone that may result in read errors. The “tail” 1212 is a region of undesirable sensitivity outside the defined betting zone. If the “tail” is sufficient to energize tokens outside the betting zone, the result may be cross-talk errors.

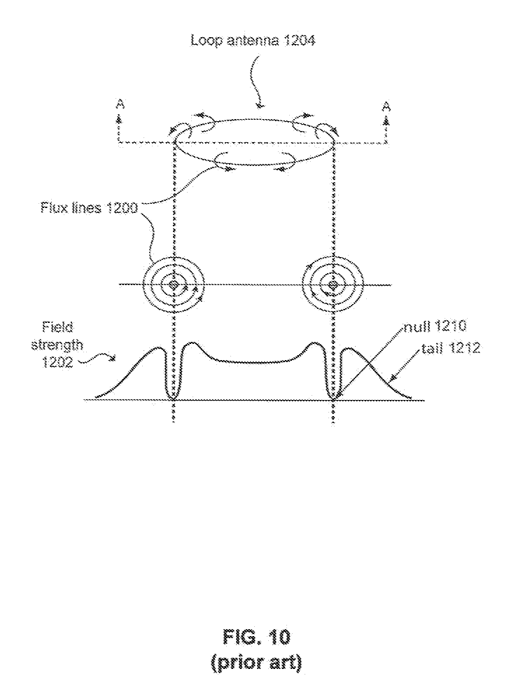

FIG. 11 shows three views of a loop antenna 1304 and a shielding loop 1306 according to an embodiment of the present invention. The top view shows a three-dimensional view of the loop antenna 1304 and the shielding loop 1306. The middle view shows a cut away side view along Section B-B of the top view, including flux lines 1300. The bottom view shows a graph of the field strength 1302 according to distance from the loop antenna 1304, including a null 1310. A distance “d” separates the loop antenna 1304 and the shielding loop 1306. A “spot” 1320 corresponds to an area interior to the loop antenna 1304 where the field strength 1302 is high. A “border” 1322 corresponds to an area outside the spot 1320 where the field strength 1302 is present except for the null 1310. Outside the spot 1320 and the border 1322, there is no field strength corresponding to the loop antenna 1304.

Comparing FIG. 11 to FIG. 10, note that the tail 1212 is significantly constrained. The shielding loop 1306 distorts the h-field generated by the antenna 1304 to constrain the tail (that would otherwise be present). Note that the particular shape of the field strength 1302 graph will depend upon the specifics of the overall reader system (e.g., the specifics of the loop antenna 1304, the shielding loop 1306, the distance “d”, etc.).

The shielding loop 1306 balances sensitivity (the ability to read RFID tags inside the antenna loop) with cross-talk (the ability to discriminate against RFID tags outside the antenna loop). FIG. 11 shows how the shielding loop 1306 is used to tune the location of the null 1310 and constrain the shape of the tail to a finite and manageable border 1322. From the perspective of designing a gaming table with clearly defined betting zones, the space “d” between the antenna and the shielding loop has both positive and negative attributes. On the positive side, a smaller gap “d” results in a tighter border around the betting zone and reduces cross-talk. On the negative side, a smaller gap “d” will cause the field to collapse—reducing overall sensitivity within the betting zone and thereby reducing the read range (i.e. how high one can stack the gaming tokens and still get accurate data). The gap “d” may be a constant distance between the shielding loop 1306 and the loop antenna 1304. The gap “d” may be a variable gap according to other embodiments, as desired, for example to fine-tune the field shape or for other purposes.

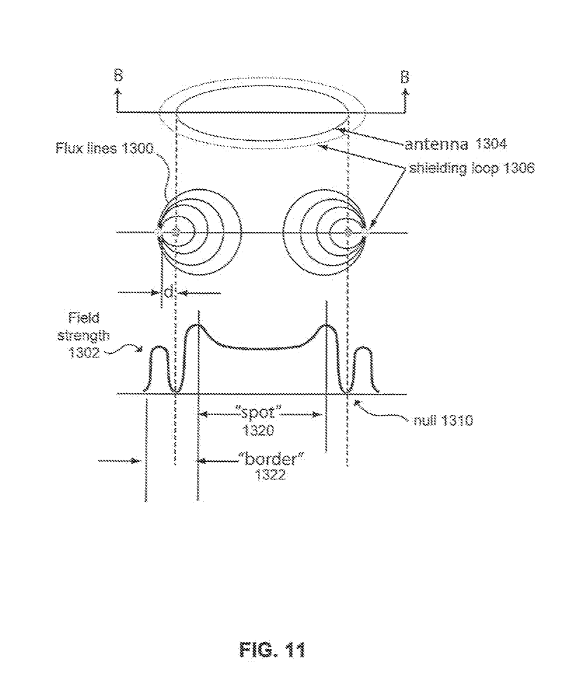

FIG. 12 shows three views of a loop antenna 1404 and a shielding loop 1406 according to an embodiment of the present invention. The top view shows a three-dimensional view of the loop antenna 1404, the shielding loop 1406, and a stack of RFID tokens 1430. The middle view shows a cut away side view along Section C-C of the top view, including flux lines 1400. The bottom view shows a graph of the field strength 1402 according to distance from the loop antenna 1404. The stack of RFID tokens 1430 may include ferrite cores as discussed above.

Comparing FIG. 12 to FIG. 11, note that the flux lines 1400 are distorted (as compared to the flux lines 1300) by the presence of the tokens 1430. The ferrite cores steer the magnetic flux up the stack of RFID tags inside the betting zone border with the active antenna. Tags outside the border do not benefit from this coupling. This difference results in the ability to discriminate between tokens inside a defined border and tokens outside the border. The greater this ability to discriminate, the more well-defined the border. Further note that the field strength 1402 is increased (as compared to the field strength 1302) by the presence of the tokens 1430.

The embodiment of FIG. 11 or the embodiment of FIG. 12 may be incorporated with other embodiments shown in other figures, for example, FIG. 1A, FIG. 4, or FIG. 7.

In summary, the shielding loop 1306 can be placed around the excitation antenna 1304 in a manner that defines the border 1322 around a betting spot 1320 while retaining sufficient sensitivity inside the betting spot 1320. A noteworthy design factor is the comparison between the signal strength of the top tag of a stack of tokens 1430 placed inside the border 1322 with the signal strength of a bottom tag outside the border 1322. The ability to differentiate between the two (along with the design of the circuit) may help determine the width of the border 1322 around a betting spot 1320.

According to an embodiment, an excitation power of 1 Watt drives the antenna 1304. The shielding loop 1306 may be located outside of the antenna 1304 with a distance “d” of 0.5 inches. The shielding loop 1306 may be located outside of the antenna 1304 with a distance “d” of 0.125 inches. Note that placing the shielding loop 1306 too close to the excitation antenna 1304 has a negative impact on signal strength.

According to an embodiment, the gaming table 700 (see FIG. 4) includes a covering over the antennas. The covering may have visual indicators of the betting areas. The covering may include felt or padding. The thickness of the covering may be referred to as the “table gap”. Various table gaps may be used in various embodiments, including 0 inches (no covering), 0.25 inches, 0.5 inches, and 0.75 inches.

According to an embodiment, the antenna 1304 may have a trace width of 0.25 inches. According to an embodiment, the shielding loop may have a trace width of 0.25 inches. According to an embodiment, the shielding loop may be formed as a copper trace on the printed circuit board that also contains the excitation antenna. Other materials may be used in other embodiments. The shielding loop trace may be approximately 0.125 inches wide and separated from the excitation antenna by 0.25 inches (i.e., the center of the antenna loop trace is 0.5 inches from the center of the shielding loop trace). Other dimensions may also be implemented in other embodiments. As noted above, the gap between antenna and shielding loop is a tradeoff between the desire to extend the read range (bigger gap) and the desire to sharply define the border of the betting zone (smaller gap). The extreme case of needing a sharply defined border is when multiple antennas abut each other.

One performance measurement that may be used when evaluating embodiments of the present invention is the “10 dB discrimination distance”. The 10 dB discrimination distance is a metric that defines a distance from the border of a defined read region at which point the signal strength from an RFID tag outside this distance is at least 10 dB less than the weakest signal from any RFID tag inside the read region. For example, in a gaming table embodiment, a token outside the betting zone has a signal strength at least 10 dB less than the weakest signal from any token inside the betting zone. The tokens inside the betting zone may be stacked (e.g., 30 tokens stacked) and the tokens outside the betting zone may be stacked adjacent to the inside tokens, and the 10 dB discrimination distance criterion is met according to an embodiment of the present invention.

The 10 dB discrimination distance is a non-dimensional ratio that is independent of absolute signal strength and antenna geometry. The 10 dB discrimination distance may be used to measure RFID systems without the shielding loop, for comparison purposes. As an example, the 10 dB discrimination distance for an antenna without a shielding loop is 3 or more inches; using the same antenna with a shielding loop, the 10 dB discrimination distance is less than zero (that is, tokens inside that are adjacent to tokens outside result in more than 10 dB difference in signal strength).

Antenna Shorting

As mentioned above, one feature of an embodiment of the present invention is the ability of the RFID reader to short out one or more antennas in proximity to a driven element in a specific betting zone. This avoids the opportunity for sympathetic resonance in the adjacent (non-driven) antennas. This sympathetic resonance degrades the quality of the “border” of the target betting zone—thereby making discrimination more difficult.

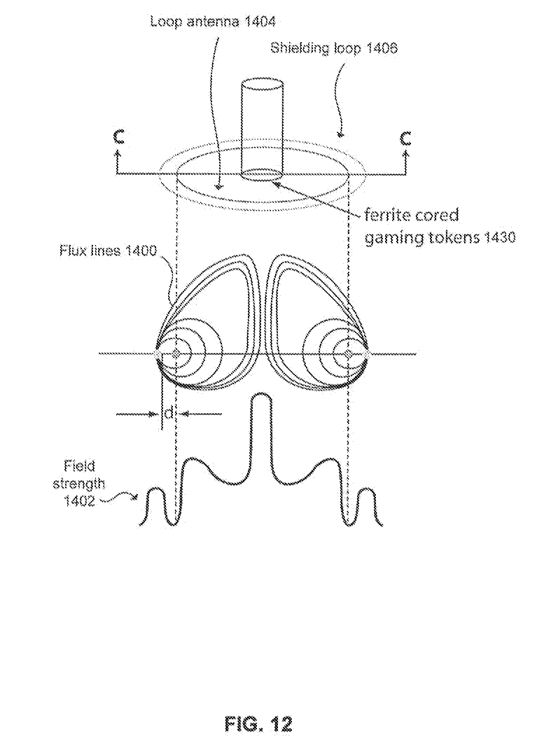

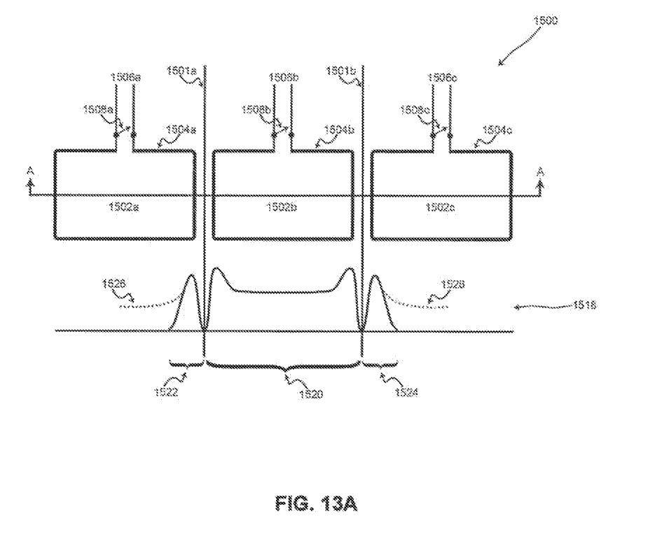

FIG. 13A shows a schematic representation of an array 1500 of antennas (such as might be used on a roulette or baccarat table), according to an embodiment of the present invention. The array 1500 includes betting zones 1502 (individually 1502a-1502c), loop antennas 1504 (individually 1504a-1504c), leads 1506 (individually 1506a-1506c), and switches 1508 (individually 1508a-1508c). (Note that in this schematic representation, each element in the array is identical to its neighboring antenna.)

The betting zones 1502 define areas where gaming tokens are placed. In the array 1500 as shown, the betting zones 1502 are relatively close to each other. There is one loop antenna 1504 per betting zone 1502. The leads 1506 connect the loop antennas 1504 to the RFID reader (not shown). The leads 1506 transmit electromagnetic energy from the RFID reader; the loop antennas 1504 generate the excitation field; and the leads 1506 transfer information between any tags responsive to the excitation field and the RFID reader. The switches 1508 may be activated to selectively short out each of the loop antennas 1504. The switches 1508 may be controlled by the RFID reader via the leads 1506. The loop antennas 1504 and the switches 1508 may be similar to the components discussed above regarding FIG. 7 (note the loop antenna 1008 and the switch 1004). FIG. 13 only shows a 1 by 3 array, but a similar discussion also applies to a two dimensional array of antennas such as 3 by 3.

FIG. 13A also shows a cross-sectional view 1518 (along line A-A of FIG. 13A) of an example field strength for the array 1500 in two different cases: with and without neighboring antennas 1504a and 1504c shorted. In the case where the neighboring antennas 1504a and 1504c are not shorted, these neighboring antennas exhibit sympathetic resonances represented by the dashed lines 1526 and 1528. In the case where the neighboring antennas 1504a and 1504c are shorted, the regions 1522 and 1524 show a steep drop off in field strength as one moves away from the betting zone of interest 1502b (region 1520). In both cases, the signal strength remains relatively high in the region 1520 corresponding to the loop antenna 1504b and its corresponding betting zone 1502b.

Consider that the RFID reader is attempting to identify the tokens in betting zone 1502b. Moving a token along line A-A, the token encounters two cases: adjacent antennas shorted and not shorted. Shorting the adjacent antennas (in betting zones 1502a and 1502c) constrains the excitation field outside the target betting zone 1502b and minimizes undesirable cross-talk from adjacent betting zones.

FIG. 13B shows a standard layout for a roulette table 2100. Bets can be placed directly over a number 2101a, on a line between two numbers 2101b, or on an intersection between four numbers 2101c.

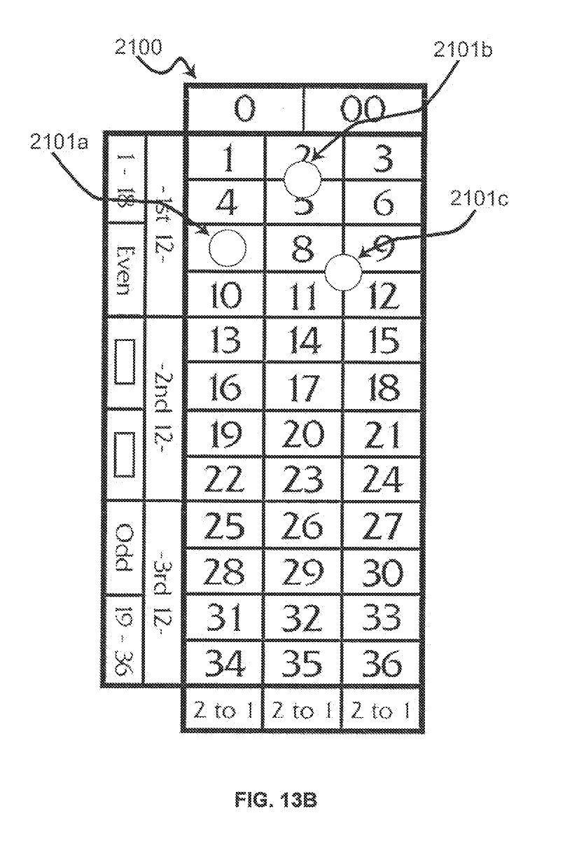

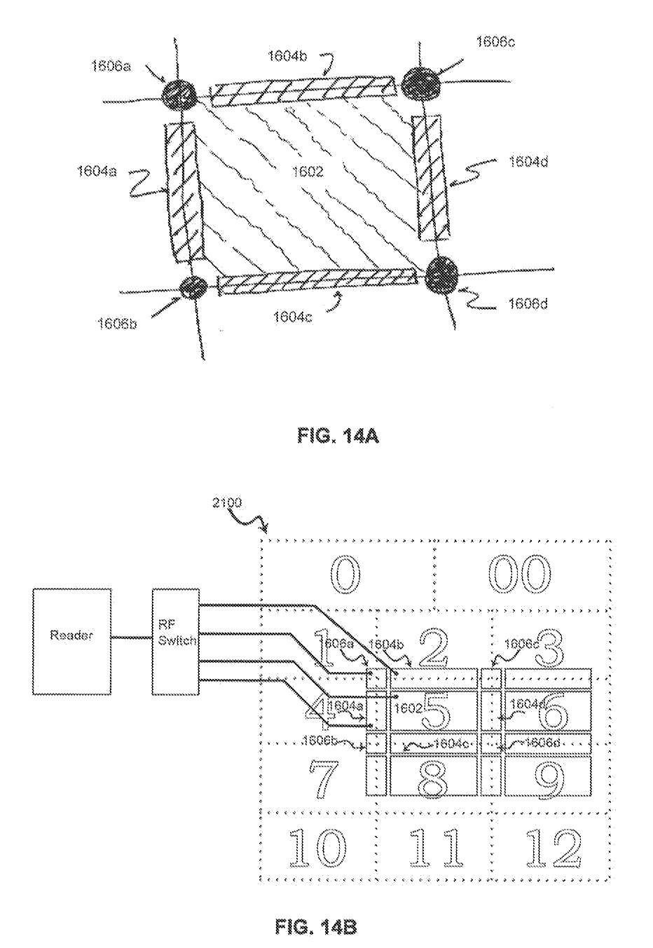

FIG. 14A is a diagram showing betting zones of different geometries, according to an embodiment of the present invention. FIG. 14A shows how the embodiment of FIG. 13B can be adjusted for different geometries of betting zones. FIG. 14A shows three types of betting zones on a single betting surface: an area zone 1602, four line zones 1604 (individually 1604a-1604d), and four spot zones 1606 (individually 1606a-1606d).

All three of these types of betting zones can be found in roulette as shown in FIG. 13B. FIG. 14A does not show the actual geometries of the antenna loops—which must be tailored to the specific needs of each gaming environment. Variables that come into play include: the layout of each table, the sensitivity of the tags, and the maximum stack height to be played on each spot. Embodiments for the “spot” zones are approximately the size of an individual betting token (1.5 inches in diameter) but can be as small as 0.5 inches (the size of the ferrite cores described earlier). Embodiments of the “line” zones are similar in width to the “spot” zones and are typically 3 to 4 inches in length, corresponding to the lines that separate adjacent numbers on a layout for roulette. Embodiments of the “area” zones are typically 3 inches by 4 inches, corresponding to the layout for each number on a layout for roulette. According to other embodiments, the antennas may (or may not) overlap each other—with the detailed geometry tailored to the specifics of individual gaming tables. Regardless of the detailed geometry, embodiments short out adjacent antennas to improve discrimination and thereby identify the location of each token on the betting surface of the table.

FIG. 14B shows one embodiment of the control structure for the roulette table 2100 (see FIG. 13B), with each reader connected via a 1:4 multiplexer and configured to drive four antennas: the primary spot (area type) 1602, the top and left sides (line type) 1604b and 1604a, and the top-left intersection (spot type) 1606a. Multiple readers configured in a similar manner cover the entire table 2100 with one reader used for each primary spot. In addition to the multiplexed signal driving the four antennas corresponding to each primary spot, there are four shorting switches.

According to an embodiment, the control steps are as follows. First, command all readers to read their respective primary spots while all other antennas are shorted. This assures that there are no adjacent antennas being read at the same time and thus minimal interference/cross-talk. In one embodiment, this read cycle takes 200 milliseconds. Second, command all readers to read their respective top line while all other antennas are shorted. Third, command all readers to read their respective left side while all other antennas are shorted. Fourth, command all readers to read their respective top-left intersection while all other antennas are shorted. Total time to read an entire table is approximately 800 milliseconds. The time to switch between antennas is less than 1 millisecond.

In this embodiment, the readers are all connected to one or more processors, and antenna selection is controlled by two lines to each reader. Other methods for antenna selection are also possible.

As noted earlier, signal strength is the primary method for assigning a specific tag to a specific zone. If two zones read a tag with identical signal strength, additional processing (e.g. multiple read cycles) may be used in an attempt to arbitrate. For example, many readers are designed to output a signal strength along with the ID of the tag. One common metric is a value between 0 and 7 with higher values corresponding to stronger signals. Texas Instruments equipment generates two such values for two independent channels (main and auxiliary). Multiple techniques for arbitration may be used, including: (1) if two readers provide similar values for the main channel one can look at the signal strength measured by the auxiliary channel, (2) one can make multiple readings, (3) one can dither the strength of the excitation signal. According to an embodiment, the two signal strengths are “similar” if they generate the same value in the 0-7 scale. In another embodiment, the two signal strengths are “similar” if one is within 95% of the other.

As discussed above regarding the shielding loop (surrounding a single antenna with no neighbors), the 10 dB discrimination distance is a goal according to an embodiment by shorting adjacent antennas. In the case where you have closely spaced antennas, if you do not short the adjacent antennas, the shield loop helps but the sympathetic resonance hurts. By shorting the adjacent antennas, one is able to eliminate the sympathetic resonance and achieve the results similar to a single antenna (no neighbors) with a shield loop.

As a specific example, the 10 dB discrimination distance may be used to measure RFID systems without short adjacent antennas, for comparison purposes. As an example, the 10 dB discrimination distance for an antenna without shorting adjacent antennas is 3 or more inches; using the same antenna with shorting adjacent antennas, the 10 dB discrimination distance is less than zero (that is, tokens inside that are adjacent to tokens outside result in more than 10 dB difference in signal strength).

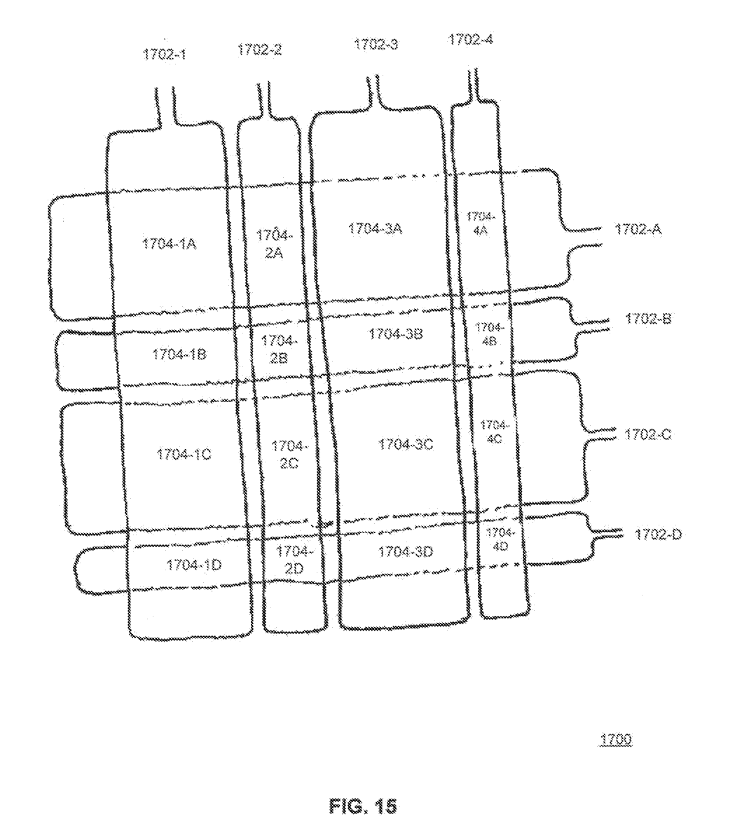

FIG. 15 shows yet another embodiment of the present invention using two orthogonal arrays of linear antennas 1700. FIG. 15 shows how these linear arrays can be arranged to create the three types of read zones (area, line, and spot) described earlier. The vertical array elements are 1702-1, 1702-2, 1702-3 and 1702-4. The horizontal array elements are 1702-A, 1702-B, 1702-C and 1702-D. The intersections 1704 of the array elements are labeled according to the combined vertical and horizontal labels, e.g., 1704-1A. Signal strength information from each of the two orthogonal arrays determines the intersection within which the RFID tag is located. In this embodiment, each linear array alternates between a wide antenna and a narrow antenna. This results in 1704-1A, 1704-3A, 1704-1C, and 1704-3C representing “area” type; 1704-1B, 1704-1D, 1704-2A, 1704-2C, 1704-3B, 1704-3D, 1704-4A, and 1704-4C representing “line” type, and 1704-2B, 1704-4B, 1704-2D, and 1704-4D representing “spot” type betting zones. This embodiment implements fewer antennas without a loss of spatial resolution.

The read algorithm according to an embodiment is discussed below. One constraint is that the horizontal and vertical antennas cannot be read at the same time. Another constraint is that adjacent antennas cannot be read at the same time. The process to read the antennas is as follows. First, every other vertical antenna is read (connected) at the same time (in this example, the odd-numbered antennas 1702-1 and 1702-3) while the remaining vertical antennas are shorted (in this example, the even-numbered antennas 1702-2 and 1702-4) and the horizontal antennas are left open (in this example, 1702-a, b, c, d). Second, the odd-numbered antennas are shorted while the even-numbered antennas are read. Third, this pattern is then repeated for the horizontal antennas. (More generally, the above process may be referred to as connecting and shorting subsets of the antennas, or as selectively shorting neighboring antennas.) Fourth, tags must be read by both vertical and horizontal antennas to be counted. The location of an individual tag is determined by the intersection of the vertical and horizontal antennas that successfully read the tag.

Read times are typically 200 milliseconds, with a resulting ability to read an entire table in approximately 800 milliseconds. Switching times are again less than 1 millisecond. One rationale for this embodiment is to reduce the number of readers and antennas while retaining spatial resolution and read cycle performance.

As noted earlier, signal strength is the primary method for assigning a specific tag to a specific zone. If two zones read a tag with identical signal strength, additional processing (e.g. multiple read cycles) may be used in an attempt to arbitrate. For example: many readers are designed to output a signal strength along with the ID. One common metric is a value between 0 and 7 with higher values corresponding to stronger signals. Texas Instruments generates two such values for two independent channels (main and auxiliary). Multiple techniques for arbitration are possible including: (1) if two readers provide similar values for the main channel one can look at the signal strength measured by the auxiliary channel, (2) one can make multiple readings, (3) one can dither the source strength.

As noted earlier, the spatial resolution required when locating a tag is dependent on one's ability to assess signal strength differences and control the excitation field in a manner wherein these differences are meaningful. Embodiments of the antenna shorting described in this document are generally one of several methods for improving the measurement of signal strength differences. Thus, it is possible to combine the antenna shorting with other techniques (e.g. ferrite core, shielding loop) to further improve discrimination.

Antenna Shorting and Ferrite Core

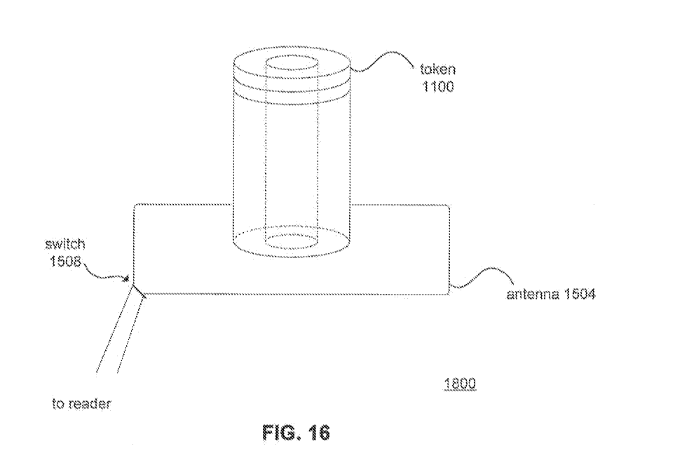

FIG. 16 illustrates a system 1800 according to an embodiment of the present invention. The system 1800 combines antenna shorting (see, e.g., FIG. 13A) and ferrite core tags (see, e.g., FIG. 8A). The system 1800 includes a loop antenna 1504, a switch 1508, and a number of tokens 1100. The loop antenna 1504, switch 1508 and the tokens 1100 may be as described above (including variations thereof). The system 1800 includes other adjacent and neighboring loop antennas (not shown; see, e.g., FIG. 14B), each with their corresponding components (not shown; e.g., switch, etc.).

Shorting adjacent antennas effectively collapses the excitation field, which can reduce the read range (stack height) within the betting zone below acceptable limits. Ferrite cored gaming tokens have been shown to increase the efficiency of energy and data transfer between readers and tags. This ability to steer an excitation field dramatically improves discrimination (even without a shield loop) between proximal antennas—however—when closely spaced antennas resonate sympathetically, the ability to discriminate is impacted negatively. Combining the two aspects (ferrite core+antenna shorting) minimizes sympathetic resonance and thereby improves discrimination.

Antenna Shorting and Shielding Loop

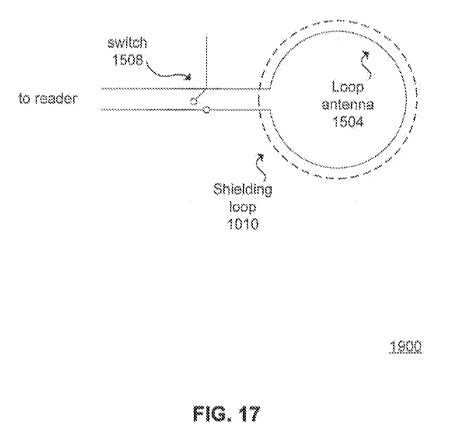

FIG. 17 illustrates a system 1900 according to an embodiment of the present invention. The system 1900 combines antenna shorting (see, e.g., FIG. 13A) and a shielding loop (see, e.g., FIG. 7). The system 1900 includes a loop antenna 1504, a switch 1508 and a shielding loop 1010. The loop antenna 1504, switch 1508 and shielding loop 1010 may be as described above (including variations thereof). The system 1900 includes other adjacent and neighboring loop antennas (not shown; see, e.g., FIG. 14B), each with their corresponding components (not shown; e.g., switch, etc.).

Adding a shielding loop around an antenna effectively collapses the excitation field and reduces the read range (e.g. the stack height within the betting zone). Combining the two aspects (antenna shorting and shielding loop) minimizes sympathetic resonance from neighboring antennas and thereby improves discrimination

Antenna Shorting, Shielding Loop and Ferrite Core

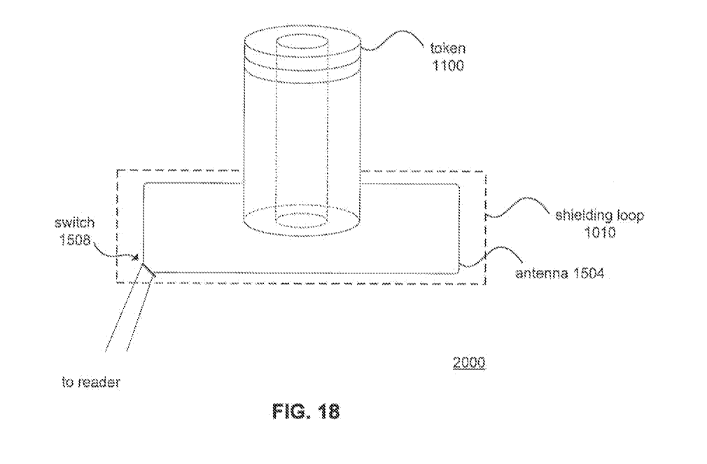

FIG. 18 illustrates a system 2000 according to an embodiment of the present invention. The system 2000 combines antenna shorting (see, e.g., FIG. 13A), ferrite core tags (see, e.g., FIG. 8A), and a shielding loop (see, e.g., FIG. 7). The system 2000 includes a loop antenna 1504, a switch 1508, a number of tokens 1100, and a shielding loop 1010. The loop antenna 1504, switch 1508, tokens 1100, and shielding loop 1010 may be as described above (including variations thereof). The system 2000 includes other adjacent and neighboring loop antennas (not shown; see, e.g., FIG. 14B), each with their corresponding components (not shown; e.g., switch, etc.).

Combining all three aspects (antenna shorting+shielding loop+ferrite core) has the most dramatic impact on discrimination between closely spaced antennas. The ferrite core extends the read range in the desired direction (maximum stack height of gaming tokens inside the betting zone) while minimizing the cross-talk from by (1) collapsing the field outside the target betting zone and (2) eliminating sympathetic resonance from neighboring antennas.

### Additional Embodiments

Although an embodiment discusses “orthogonal” arrays of antennas, note that two arrays need not be precisely orthogonal in order to implement other embodiments. If orthogonal is defined as 90 degrees apart (90 degrees offset), other embodiments may have other degrees of apartness, such as 30 degrees, 45 degrees, and 60 degrees. More generally, the direction of a first set of the antennas is “offset” from the direction of a second set of antennas. (The offset for the embodiment shown in FIG. 15 may be described as “90 degrees”, “perpendicular” or “orthogonal”.)

As noted earlier, the one intent of the orthogonal physical arrangement is to reduce the number of readers in a system without losing spatial resolution. If the objective is to locate a point on a plane, one effective means is to use two orthogonal axes (e.g. “x” and “y”). But other geometries can be equally effective—for example: polar coordinates (e.g. angle and distance). Other practical approaches may use two (or more) non-orthogonal coordinates to locate a position. (Note that non-orthogonal coordinate systems may be less efficient.)

The antennas 1504 (see FIG. 13A) can be in various states by default, and reading can be controlled by selectively connecting or disconnecting various of the antennas 1504, for example via the switches 1508. In a first example, the antennas are normally in a connected state; the reader shorts neighboring antennas and reads from a first antenna. In a second example, the antennas are normally in a shorted state; the reader connects a first antenna and refrains from connecting the neighboring antennas.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A radio frequency identification (RFID) system, comprising:
a reader system that is configured to generate electromagnetic energy;
a plurality of reader antennas, coupled to the reader system, that is configured to communicate information with a RFID tag using the electromagnetic energy; and
a plurality of switches, coupled to the plurality of reader antennas,
wherein the reader system is configured to selectively control the plurality of switches to short neighboring ones of the plurality of reader antennas.

2. The RFID system of claim 1, further comprising:
a plurality of shield loops, each of which surrounds a corresponding one of the plurality of reader antennas, wherein a magnetic field communicated by one of the plurality of reader antennas is distorted by one of the plurality of shield loops in a manner that improves a definition of a border of a read region.

3. The RFID system of claim 1, wherein the RFID tag comprises:
a ferrite core;
an antenna that receives the electromagnetic energy; and
tag electronics, coupled to the antenna, that are configured to identify the RFID tag in response to receiving the electromagnetic energy.

4. The RFID system of claim 1, further comprising:
a plurality of shield loops, each of which surrounds a corresponding one of the plurality of reader antennas, wherein a magnetic field communicated by one of the plurality of reader antennas is distorted by one of the plurality of shield loops in a manner that improves a definition of a border of a read region.
wherein the RFID tag comprises:
a ferrite core;
an antenna that receives the electromagnetic energy; and
tag electronics, coupled to the antenna, that identify the RFID tag in response to receiving the electromagnetic energy.

5. The RFID system of claim 1, further comprising:
a plurality of RFID tags, wherein the plurality of RFID tags respectively includes a plurality of ferrite cores, wherein the ferrite cores steer a magnetic field in a direction in which the plurality of RFID tags are stacked.

6. The RFID system of claim 1, wherein one of the plurality of reader antennas has a form factor of an area antenna.

7. The RFID system of claim 1, wherein one of the plurality of reader antennas has a form factor of a line antenna.

8. The RFID system of claim 1, wherein one of the plurality of reader antennas has a form factor of a spot antenna.

9. The RFID system of claim 1, wherein the plurality of reader antennas begin in a connected state, and wherein the reader system shorts the neighboring ones.

10. The RFID system of claim 1, wherein the plurality of reader antennas begin in a shorted state, and wherein the reader system connects a selected antennas of the plurality of reader antennas.

11. The RFID system of claim 1, wherein the plurality of reader antennas begin in a connected state, wherein the plurality of reader antennas includes a first antenna that neighbors the neighboring ones of the plurality of reader antennas, and wherein the reader system shorts the neighboring ones.

12. The RFID system of claim 1, wherein the plurality of reader antennas begin in a shorted state, wherein the plurality of reader antennas includes a first antenna that neighbors the neighboring ones of the plurality of reader antennas, and wherein the reader system is further configured to selectively control the plurality of switches to connect the first antenna.

13. The RFID system of claim 1, wherein the reader system is configured to perform a second reading if two of the plurality of reader antennas read the RFID tag with similar signal strengths.

14. A radio frequency identification (RFID) system, comprising:
a reader system that is configured to generate electromagnetic energy; and
a plurality of reader antennas, coupled to the reader system, that are configured to communicate information with a plurality of RFID tags using the electromagnetic energy,
wherein the plurality of reader antennas includes a first set of reader antennas and a second set of reader antennas, wherein the first set of reader antennas are arranged in a first direction, wherein the second set of reader antennas are arranged in a second direction offset from the first direction, and wherein the first set of reader antennas intersects the second set of reader antennas to define a plurality of read zones.

15. The RFID system of claim 14, further comprising:
a plurality of switches, coupled to the plurality of reader antennas,
wherein the reader system is configured to selectively control the plurality of switches to connect and short a first subset of the first set of reader antennas, to connect and short a second subset of the first set of reader antennas, to connect and short a first subset of the second set of reader antennas, and to connect and short a second subset of the second set of reader antennas.

16. The RFID system of claim 14, further comprising:
a plurality of switches, coupled to the plurality of reader antennas,
wherein the reader system is configured to selectively control the plurality of switches to short neighboring ones of the plurality of reader antennas.
